(19) United States
(12) Patent Application Publication
(10) Pub. No.: US 2026/0338349 A1
(43) Pub. Date: Oct. 29, 2026

(54) VEHICLE EXTERIOR COMPONENT

(71) Applicant: TOYODA GOSEI CO., LTD., Kiyosu-shi (JP)

(72) Inventors: Hiroko SHIBAKAWA, Aichi (JP); Masaki SENDA, Aichi (JP); Koji OKUMURA, Aichi (JP); Kazuki TAKAO, Aichi (JP); Takayasu IDO, Aichi (JP); Masaki OKADA, Aichi (JP); Yasuhisa KUMAMOTO, Aichi (JP); Naoki TAKEDA, Aichi (JP)

(21) Appl. No.: 19/654,572

(22) Filed: Apr. 22, 2026

(30) Foreign Application Priority Data
Apr. 25, 2025 (JP) 2025-073680

(51) Int. Cl. F21S 43/33; B60Q 1/30; B60Q 1/50; F21S 43/14; F21S 43/239; F21S 43/245; F21S 43/247; F21V 9/40; F21W 104/00; F21Y 101/00

(52) U.S. Cl. CPC F21S 43/331; B60Q 1/302; B60Q 1/503; F21S 43/239; F21S 43/245; F21S 43/247; F21V 9/40; F21S 43/14; F21W 2104/00; F21Y 2101/00

(57) ABSTRACT

A vehicle exterior component includes: a panel portion; and an illumination unit disposed on a back side of the panel portion, the panel portion includes a transparent or translucent base material configured to transmit light emitted from a light source of the illumination unit, a light shielding layer provided on a back side of the base material and configured to shield the light, and an interference pigment layer provided between the base material and the light shielding layer and containing a lustrous pigment that emits an interference color in response to light from an external environment, and the panel portion has a light-transmitting region in which a pattern is illuminated by the light emitted from the light source, and the light-transmitting region is formed by plural light-transmitting holes that each penetrate the light shielding layer and have a bottom surface reaching or closely facing the interference pigment layer.

### CROSS-REFERENCE TO RELATED APPLICATION

This application is based on and claims priority under 35 USC 119 from Japanese Patent Application No. 2025-073680 filed on Apr. 25, 2025.

### TECHNICAL FIELD

The present invention relates to a vehicle exterior component that causes a prescribed pattern to appear on a design surface by light emitted from a light source.

### BACKGROUND ART

A technique is known in the conventional art in which, in a vehicle exterior component such as an emblem, a design surface is constituted by a panel member in which a colored layer is laminated on a transparent base material, the colored layer is provided with a plurality of fine light-transmitting holes, and a prescribed pattern appears when a light source is turned on (for example, refer to Patent Literature 1 below).

However, the light-transmitting holes that are originally desired to be hidden may be conspicuous except when the light source is turned on (that is, when the light source is turned off), and a design property when the light source is turned off may deteriorate. In particular, the light-transmitting holes have high visibility when diameters thereof are large. For this reason, there is a demand for a vehicle exterior component that blends in with surroundings and has inconspicuous light-transmitting holes except when a light source is turned on.
Patent Literature 1: JP2005-88652A

### SUMMARY

The present invention is made to solve such a problem, and an object of the present invention is to provide a vehicle exterior component that can illuminate a prescribed pattern with light emitted from a light source and make presence of light-transmitting holes inconspicuous when the light source is turned off.

According to the present invention, a vehicle exterior component includes:
a panel portion; and
an illumination unit disposed on a back side of the panel portion,
in which the panel portion includes
   a transparent or translucent base material configured to transmit light emitted from a light source of the illumination unit,
   a light shielding layer formed on a back side of the base material and configured to shield the light emitted from the light source, and
   an interference pigment layer formed between the base material and the light shielding layer and containing a lustrous pigment that emits an interference color in response to light from an external environment, and
in which the panel portion is formed with a light-transmitting region in which a prescribed pattern is illuminated by the light emitted from the light source, and the light-transmitting region is formed by an aggregate of a plurality of light-transmitting holes that each penetrate the light shielding layer and have a bottom surface reaching or closely facing the interference pigment layer.

According to the vehicle exterior component configured as described above, light emitted from the light source transmits through the light-transmitting hole, the interference pigment layer, and the base material, and a prescribed pattern in the light-transmitting region can be illuminated. In addition, when the light source is turned off, the interference color by the lustrous pigment in response to light from the external environment is similarly emitted regardless of whether the light-transmitting hole is present, and thus the presence of the light-transmitting hole can be made inconspicuous.

The vehicle exterior component according to the present invention may further include an adjustment unit configured to adjust a color of light emitted from the light-transmitting region to the outside of the vehicle using a color complementary to the interference color.

In this way, when the color of the light emitted from the light-transmitting region to the outside of the vehicle changes due to an interference operation of the lustrous pigment, the color of the light can be returned to an original target color.

### BRIEF DESCRIPTION OF DRAWINGS

FIG. 1 is a perspective view of a vehicle including a vehicle exterior component according to an embodiment of the present invention;

FIG. 2 is a perspective view showing a back side of the vehicle exterior component in FIG. 1;

FIG. 3 is a cross-sectional view taken along a line III-III in FIG. 1;

FIGS. 4A and 4B schematically show a polarizing pearl pigment;

FIGS. 5A and 5B show operations and effects of the same embodiment; and

FIG. 6 shows a modification in which a complementary color layer is added.

### DESCRIPTION OF EMBODIMENTS

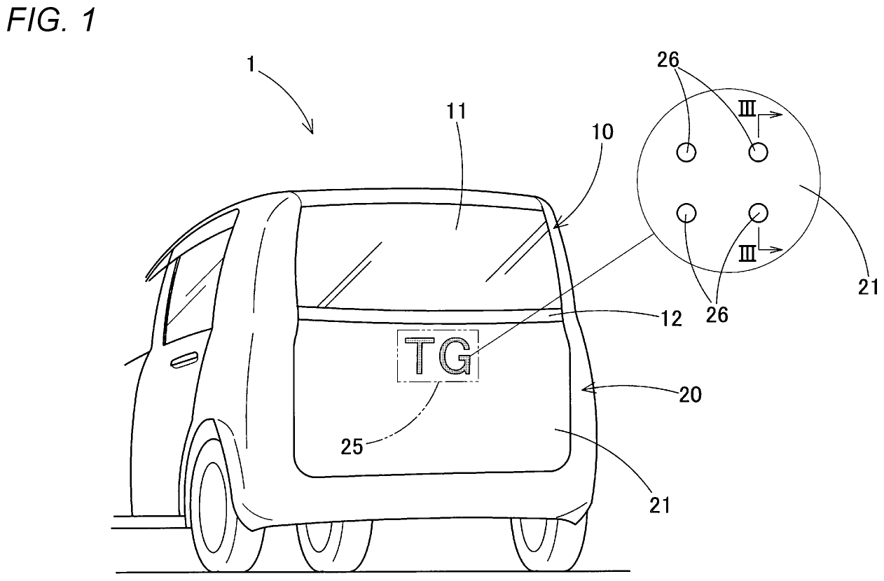

Hereinafter, an embodiment of the present disclosure will be described with reference to the drawings. FIG. 1 is a perspective view of a vehicle including a vehicle exterior component according to an embodiment of the present invention. As shown in FIG. 1, a back door 10 of a vehicle 1 includes a window portion 11 and a door body portion 12. The door body portion 12 of the back door 10 is provided with a back door garnish 20 as a vehicle exterior component.

The back door garnish 20 includes a panel portion 21 across the back door 10 in a vehicle left-right direction. The panel portion 21 is a member constituting a design surface, and is formed with a light-transmitting region 25 in a substantially central portion in the vehicle left-right direction. In the present embodiment, letters “T” and “G” in the light-transmitting region 25 can be illuminated, and a large number of fine light-transmitting holes 26 are formed in positions corresponding to the letters “T” and “G” in the light-transmitting region 25, as shown in an enlarged view of a part of the figure.

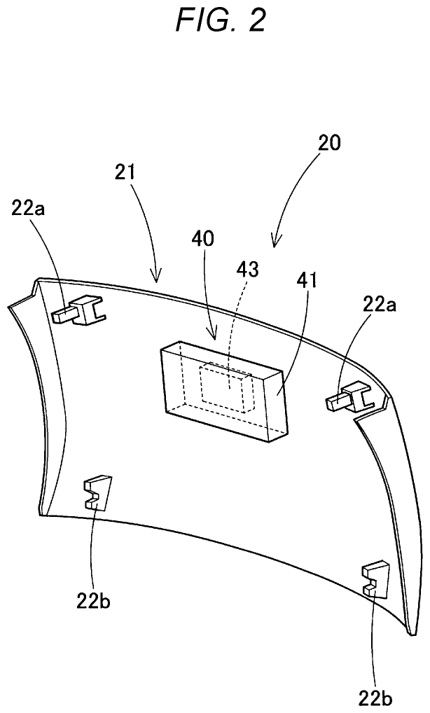

FIG. 2 is a perspective view showing a back side of the back door garnish 20. As shown in the drawing, the panel portion 21 is provided with, on a back side (vehicle interior side) thereof, in addition to engagement portions 22a and 22b that engage with the door body portion 12, an illumination unit 40 at a position corresponding to the light-transmitting region 25.

The illumination unit 40 includes a housing 41 and a light source 43 provided inside the housing 41. As the light source 43, for example, a light emitting diode that generates visible light can be used.

The housing 41 is provided with an opening (not shown) that opens toward the panel portion 21, and illumination light emitted from the light source 43 can be transmitted to a vehicle exterior side through the light-transmitting holes 26 provided in the light-transmitting region 25.

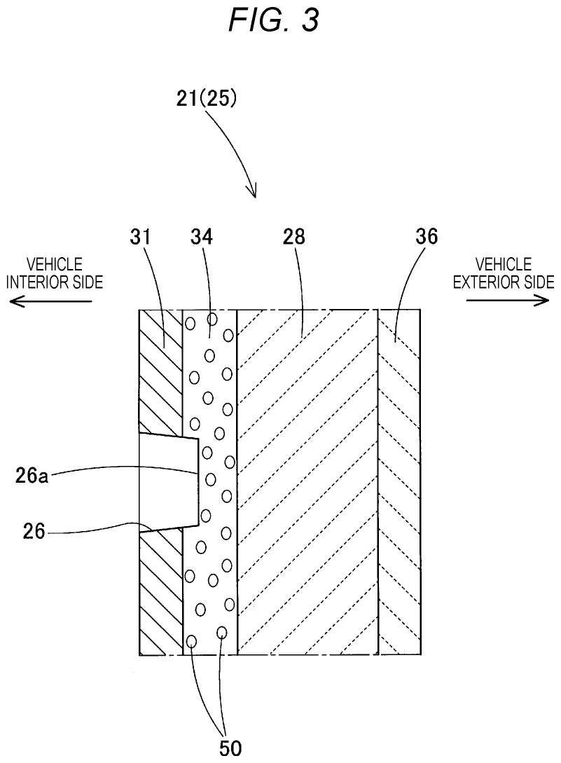

FIG. 3 shows a cross section of the panel portion 21 including the light-transmitting hole 26 provided in the light-transmitting region 25. As shown in the drawing, the panel portion 21 includes a base material 28, an interference pigment layer 34 and a light shielding layer 31 laminated on a back side (vehicle interior side) of the base material 28, and a hard coating layer 36 provided on a front side (vehicle exterior side) of the base material 28. If necessary, a transparent adhesive layer (primer layer) may be added between the base material 28 and the interference pigment layer 34 or between the base material 28 and the hard coating layer 36.

The base material 28 is made of a transparent resin such as polycarbonate resin or acrylic resin, and can be molded by a known injection molding method. The base material 28 may be made of a translucent resin that allows the illumination light emitted from the light source 43 to transmit therethrough.

The hard coating layer 36 is a transparent layer obtained by applying a known hard coating agent to a vehicle exterior side surface of the base material 28, and mainly has a function of restricting the base material 28 from damage. The hard coating layer 36 further has a function of restricting deterioration and degradation of the back door garnish 20 due to sunlight, wind and rain, temperature change, and the like.

Examples of the hard coating agent include an organic hard coating agent such as acrylate, oxetane, and silicone hard coating agents, an inorganic hard coating agent, and an organic-inorganic hybrid hard coating agent. In addition to the hard coating agent, a clear coating agent generally used for a vehicle exterior component may also be used.

The light shielding layer 31 is formed of a mixed material of a resin such as polycarbonate resin and carbon black, and absorbs the illumination light emitted from the light source 43 and blocks transmission of the illumination light. Here, carbon black is an example, and the light shielding layer 31 may be formed by mixing a material having a light blocking effect other than carbon black. In addition, the light shielding layer 31 may be a resin layer other than a black resin layer as long as the light shielding layer 31 has a function of blocking transmission of the illumination light. The light shielding layer 31 is formed to have a prescribed thickness (for example, 50 μm) on a back side (vehicle interior side) of the interference pigment layer 34 using a coating device. In FIG. 3, thicknesses of the light shielding layer 31, the interference pigment layer 34, and the like are exaggerated.

The interference pigment layer 34 is a layer obtained by mixing a lustrous pigment into a transparent or translucent resin such as acrylic resin, epoxy resin, urethane resin, or vinyl resin. In the present embodiment, a polarizing pearl pigment 50 is used as the lustrous pigment, and the interference pigment layer 34 is formed to have a prescribed thickness (for example, 50 μm) on the back side (specifically, between the base material 28 and the light shielding layer 31) of the base material 28 using a coating device.

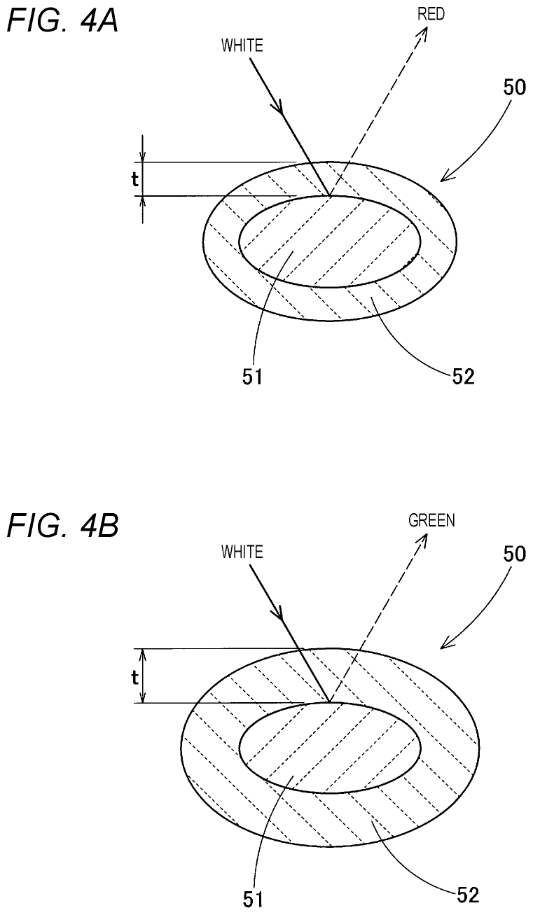

As shown in FIGS. 4A and 4B, the polarizing pearl pigment 50 is obtained by forming a transparent coating layer 52 made of a high refractive index material such as titanium dioxide on a front surface of a translucent core material 51 made of fine particles such as mica or silica.

The polarizing pearl pigment 50 having the above configuration allows the illumination light emitted from the light source 43 to transmit therethrough; on the other hand, when the light source is turned off, an interference color different from a color of incident light (light from an external environment) can be reflected by an optical interference effect implemented by partially reflecting and transmitting the incident light at an interface between two layers having different refractive indexes. As shown in FIGS. 4A and 4B, the interference color depends on a thickness t of the coating layer 52, and sequentially changes to yellow, red, blue, and green by thickening the coating layer 52. In the present embodiment, a desired interference color can be obtained by defining the thickness t of the coating layer 52 within a certain range.

Next, as shown in FIG. 3, the light-transmitting hole 26 penetrates the light shielding layer 31, has a bottom surface 26a reaching the interference pigment layer 34, and is opened to a left side (vehicle interior side) in the drawing. The light-transmitting hole 26 has a prescribed size (for example, an opening diameter of approximately φ 0.1 mm) when the panel portion 21, in which the interference pigment layer 34 and the light shielding layer 31 are formed on the base material 28, is irradiated with laser light from a light shielding layer 31 side. In the light-transmitting region 25, a prescribed pattern can be illuminated due to an aggregate of the light-transmitting holes 26.

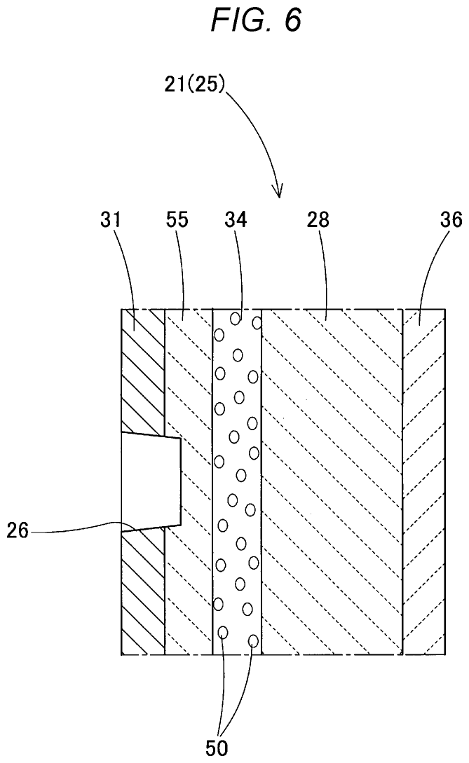

The present embodiment describes an example in which the bottom surface 26a of the light-transmitting hole 26 reaches the interference pigment layer 34. Alternatively, as shown in an example of FIG. 6, the bottom surface 26a of the light-transmitting hole 26 may closely face the interference pigment layer 34 when a layer 55 that can transmit the illumination light is interposed between the light shielding layer 31 and the interference pigment layer 34.

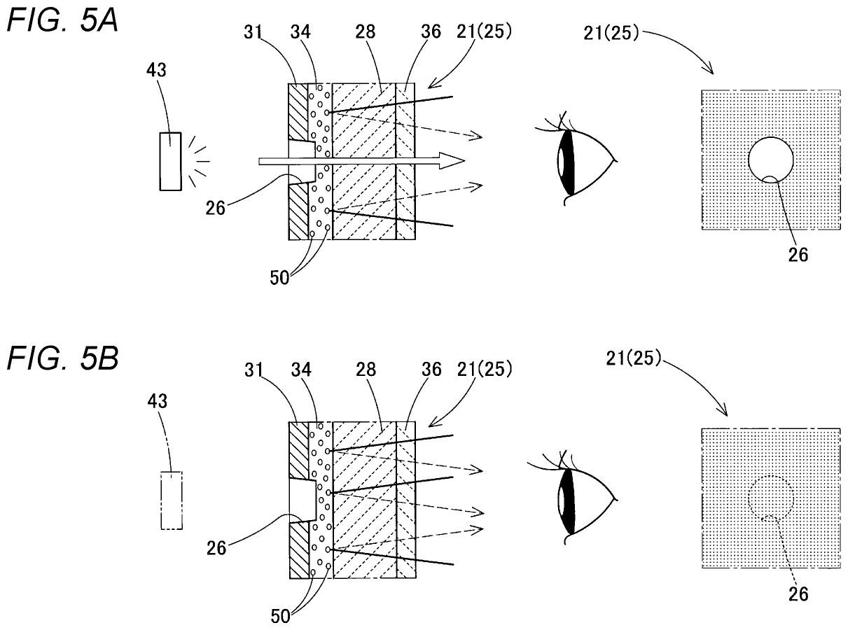

Next, operations and effects of the present embodiment will be described with reference to FIGS. 5A and 5B.

As shown in FIG. 5A, when white illumination light is emitted from the light source 43 (that is, when the light source 43 is turned on), white illumination light transmits through the light-transmitting hole 26, the interference pigment layer 34, and the base material 28 and is emitted to the vehicle exterior side. Accordingly, in the light-transmitting region 25 shown in FIG. 1, the letters “T” and “G” can be illuminated according to an amount of light emitted to the vehicle exterior side. Accordingly, a pattern including “T” and “G” can appear by white light on a design surface of a prescribed interference color defined by the polarizing pearl pigment 50.

On the other hand, as shown in FIG. 5B, when no illumination light is emitted from the light source 43 (that is, when the light source 43 is turned off), the interference color by the polarizing pearl pigment 50 is emitted from a part where the light-transmitting hole 26 is present, which is similar to a peripheral part where no light-transmitting hole 26 is present, and thus presence of the light-transmitting hole 26 can be made inconspicuous (that is, a hiding effect can be improved).

According to the back door garnish 20 in the present embodiment as described above, light emitted from the light source 43 transmits through the light-transmitting hole 26, the interference pigment layer 34, and the base material 28, and a prescribed pattern in the light-transmitting region 25 can be illuminated. In addition, when the light source 43 is turned off, the interference color by the polarizing pearl pigment 50 in response to light from the external environment is similarly emitted regardless of whether the light-transmitting hole 26 is present, and thus the presence of the light-transmitting hole 26 can be made inconspicuous.

FIG. 6 shows a modification of the above embodiment. In an example of FIG. 6, a complementary color layer 55 colored in a color (for example, a greenish color) complementary to the interference color (for example, red) of the polarizing pearl pigment 50 is provided. The complementary color layer 55 in the example of FIG. 6 corresponds to an adjustment unit of the present invention.

In the above embodiment, when the illumination light (for example, white) emitted from the light source 43 is shifted to an interference color side in the polarizing pearl pigment 50, as shown in the drawing, a color of light emitted from the light-transmitting region 25 to the outside of the vehicle can be returned to an original target color (for example, white) by forming the complementary color layer 55 colored in a color complementary to the interference color. In certain cases, instead of the complementary color layer 55, the light source 43 which shifts a color of the emitted light to a complementary color may be used.

In the embodiment described above, the interference pigment layer 34 is mixed with the polarizing pearl pigment 50. Alternatively, the lustrous pigment is not limited to the polarizing pearl pigment, and a lustrous pigment that can emit an interference color in response to the light from the external environment can be appropriately adopted.

For example, the lustrous pigment may be an aluminum filler obtained by forming a colored paint as a coating layer on aluminum as a core material. In such an aluminum filler, of incident light, light reflected by a front surface of the coating layer and light transmitted through the coating layer and reflected by a front surface of aluminum as the core material interfere with and strengthen each other, and thereby the aluminum filler is visually recognized as a certain color, and the same effect as that of the polarizing pearl pigment 50 can be obtained. However, since the aluminum filler has lower light transmittance than the polarizing pearl pigment 50 or causes specific flickering, it is necessary to appropriately adjust a mixing amount to obtain a hiding effect.

In addition, mica having no coating layer is also encompassed by the lustrous pigment that emits an interference color. Since mica itself includes a plurality of layers, mica can reflect in the interference color.

Although the embodiment of the present invention and the modification have been described in detail above, this is merely an example. For example, in the above embodiment, a back door garnish is described as an example of a vehicle exterior component. However, the present invention can be implemented in various modified modes without departing from the spirit of the present invention, for example, the above-described embodiment and modification can be applied to a vehicle exterior component other than the back door garnish (for example, an emblem provided at a front portion or a rear portion of a vehicle).

### REFERENCE SIGNS LIST

1 vehicle
20 back door garnish (vehicle exterior component)
21 panel portion
25 light-transmitting region
26 light-transmitting hole
28 base material
31 light shielding layer
34 interference pigment layer
40 illumination unit
43 light source
50 polarizing pearl pigment (lustrous pigment)
55 complementary color layer (adjustment unit)

What is claimed is:

1. A vehicle exterior component comprising:
a panel portion; and
an illumination unit disposed on a back side of the panel portion,
wherein the panel portion includes
a transparent or translucent base material configured to transmit light emitted from a light source of the illumination unit,
a light shielding layer provided on a back side of the base material and configured to shield the light emitted from the light source, and
an interference pigment layer provided between the base material and the light shielding layer and containing a lustrous pigment that emits an interference color in response to light from an external environment, and
wherein the panel portion is formed with a light-transmitting region in which a prescribed pattern is illuminated by the light emitted from the light source, and the light-transmitting region is formed by an aggregate of a plurality of light-transmitting holes that each penetrate the light shielding layer and have a bottom surface reaching or closely facing the interference pigment layer.

2. The vehicle exterior component according to claim 1, further comprising: an adjustment unit configured to adjust a color of light emitted from the light-transmitting region to an outside of the vehicle using a color complementary to the interference color.
